(19) United States
(12) Patent Application Publication
(10) Pub. No.: US 2011/0206347 A1
(43) Pub. Date: Aug. 25, 2011

(54) INFORMATION STORAGE MEDIUM CONTAINING SUBTITLE DATA FOR MULTIPLE LANGUAGES USING TEXT DATA AND DOWNLOADABLE FONTS AND APPARATUS THEREFOR

(75) Inventors: Kil-soo Jung, Hwaseong-gun (KR); Seong-jin Moon, Suwon-si (KR); Jung-wan Ko, Suwon-si (KR); Sung-wook Park, Seoul (KR); Hyun-kwon Chung, Seoul (KR); Jung-kwon Heo, Seoul (KR)

(73) Assignee: SAMSUNG ELECTRONICS CO., LTD., Suwon-si (KR)

(21) Appl. No.: 12/774,425

(22) Filed: May 5, 2010

Related U.S. Application Data
(62) Division of application No. 10/684,509, filed on Oct. 15, 2003.
(60) Provisional application No. 60/452,544, filed on Mar. 7, 2003.

(30) Foreign Application Priority Data
Oct. 15, 2002 (KR) 2002-62632

(51) Int. Cl. H04N 5/92

(52) U.S. Cl. 386/244; 386/E05.009

(57) ABSTRACT

An information storage medium on which video data are recorded, includes: a plurality of clips that are recording units in which the video data are stored; and text data for subtitles which are recorded separately from the plurality of clips and overlappable with an image according to the video data and then outputtable, the text data including data for providing subtitles in at least one language.

### CROSS-REFERENCE TO RELATED APPLICATIONS

This application claims priority from Korean Patent Application No. 2002-62632, filed Oct. 15, 2002, and the benefit of U.S. Provisional Application Ser. No. 60/452,544, filed Mar. 7, 2003, whose disclosures are hereby incorporated by reference in their entirety.

### BACKGROUND OF THE INVENTION

1. Field of the Invention

The present invention relates to an information storage medium on which subtitles for supporting multiple languages using text data and downloadable fonts are recorded and an apparatus therefor.

2. Description of the Related Art

Conventional digital versatile discs (DVD) use bitmap images as subtitles. Subtitle data of bitmap images are losslessly coded and recorded on a DVD, on which a maximum of 32 subtitles can be recorded.

The data structure of video data on a DVD, which is one of the several types of conventional multimedia information storage media, will now be explained.

FIG. 1 is a diagram of a data structure for a DVD.

Referring to FIG. 1, the disc space of a DVD that is a multimedia storage medium is divided into a VMG area and a plurality of VTS areas. Title information and information on a title menu are stored in the VMG area, and information on the title is stored in the plurality of VTS areas. The VMG area comprises 2 to 3 files and each VTS area comprises 3 to 12 files.

FIG. 2 is a detailed diagram of a VMG area.

Referring to FIG. 2, the VMG area includes a VMGI area storing additional information on the VMG, a VOBS area storing video information (video object) on the menu, and a backup area for the VMGI. These areas exist as one file and among them the presence of the VOBS area is optional.

In the VTS area, information on a title, which is a reproduction unit, and a VOBS, which is video data, are stored. In one VTS, at least one title is recorded.

FIG. 3 is a detailed diagram of a VTS area.

Referring to FIG. 3, a VTS area includes video title set information (VTSI), a VOBS that is video data for a menu screen, a VOBS that is video data for a video title set, and backup data of the VTSI. The presence of the VOBS for displaying a menu screen is optional. Each VOBS is again divided into VOBs and cells that are recording units. One VOB comprises a plurality of cells. The lowest recording unit mentioned in the present invention is a cell.

FIG. 4 is a detailed diagram of a VOBS that is video data.

Referring to FIG. 4, one VOBS comprises a plurality of VOBs, and one VOB comprises a plurality of cells. A cell comprises a plurality of VOBUs. A VOBU is data coded by a moving pictures expert group (MPEG) method of coding moving pictures used in a DVD. According to the MPEG method, since images are spatiotemporal compression encoded, in order to decode an image, previous or following images are needed. Accordingly, in order to support a random access function by which reproduction can be started from an arbitrary location, intra encoding which does not need previous or following images is performed for every predetermined image. This image is referred to as an infra picture or I picture in the MPEG and those between an I picture and the next I picture are referred to as a group of pictures (GOP). Usually, a GOP comprises 12 to 15 pictures.

The MPEG defines system encoding (ISO/IEC13818-1) for encapsulating video data and audio data into one bitstream. The system encoding defines two multiplexing methods, including a program stream (PS) multiplexing method which is suitably for producing one program and storing the program in an information storage medium, and a transport stream multiplexing method which is appropriate for making and transmitting a plurality of programs. In the methods, the DVD employs the PS encoding method. According to the PS encoding method, video data and audio data are respectively divided in the units of packs (PCK) and are multiplexed through time division of the packs. Data other than the video and audio data defined by the MPEG are named as a private stream and also included in PCKs so that the data can be multiplexed together with the audio and video data.

A VOBU comprises a plurality of PCKs. The first PCK in the plurality of PCKs is a navigation pack (NV_PCK). Then, the remaining part comprises video packs (V_PCK), audio packs (A_PCK), and sub picture packs (SP_PCK). Video data contained in a video pack comprises a plurality of GOPs.

The SP_PCK is for 2 dimensional graphic data and subtitle data. That is, in the DVD, subtitle data that appear overlapping a video picture are coded by the same method as used for 2 dimensional graphic data. That is, for the DVD, a separate coding method for supporting multiple languages is not employed and after converting each subtitle data into graphic data, the graphic data is processed by one coding method and then recorded. The graphic data for a subtitle is referred to as a sub picture. A sub picture comprises a sub picture unit (SPU). A sub picture unit corresponds to one graphic data sheet.

FIG. 5 is a diagram showing the relation between an SPU and SP_PCK.

Referring to FIG. 5, one SPU comprises a sub picture unit header (SPUH), pixel data (PXD), and a sub picture display control sequence table (SP_DCSQT), which are divided and recorded in this order into a plurality of 2048-byte SP_PCKs. At this time, if the last data item of the SPU does not completely fill one SP_PCK, the remaining part of the last SP_PCK is padded to have the same size as the other SP_PCKs. Accordingly, one SPU comprises a plurality of SP_PCKs.

In the SPUH, the size of the entire SPU and a location from which SP_DCSQT data begins are recorded. PXD data is obtained by encoding a sub picture. Pixel data forming a sub picture can have 4 different types of values, which are a background, a pattern pixel, an emphasis pixel-1, and an emphasis pixel-2 that can be expressed by 2 bit values and have binary values of 00, 01, 10, and 11, respectively. Accordingly, a sub picture can be deemed as a set of data having the four pixel values and formed with a plurality of lines. Encoding is performed for each line. As shown in FIG. 6, the SPU is run-length encoded. That is, if 1 to 3 predetermined pixel data items continue, the number of continuous pixels (No_P) is expressed by 2 bits and after that, a 2-bit pixel data value (PD) is recorded. If 4 to 15 pixel data items continue, the first 2 bits are recorded as 0's, then No_P is recorded by using 4 bits, and PD is recorded by using 2 bits. If 16 to 63 pixel data items continue, the first 4 bits are recorded as 0's, then No_P is recorded by using 8 bits, and PD is recorded by using 2 bits. If pixel data items continue to the end of a line, the first 14 bits are recorded as 0's, and then PD is recorded by using 2 bits. If alignment in units of bytes is not achieved when encoding of a line is finished, 4 bits are recorded as 0's. The length of encoded data in one line cannot exceed 1440 bits.

FIG. 7 is a diagram of the data structure of SP_DCSQT.

Referring to FIG. 7, SP_DCSQT contains display control information for outputting the PXD data. The SP_DCSQT comprises a plurality of sub picture display control sequences (SP_DCSQ). One SP_DCSQT is a set of display control commands (SP_DCCMD) performed at one time, and comprises SP_DCSQ_STM indicating a start time, SP_NXT_DCSQ_SA containing information on the location of the next SP_DCSQ, and a plurality of SP_DCCMD.

The SP_DCCMD is control information on how the pixel data (PXD) and video pictures are combined and output, and contains pixel data color information, information on contrast with video data, and information on an output time and a finish time.

FIG. 8 is a reference diagram showing an output situation considering sub picture data.

Referring to FIG. 8, pixel data itself is losslessly coded as PXD. SP_DCSQT contains information on an SP display area, which is a sub picture display area in which a sub picture is displayed in a video display area that is a video image area, and information on the start time and finish time of output.

In a DVD, sub picture data for subtitle data of a maximum of 32 different languages can be multiplexed with video data and recorded. Distinction of these different languages is performed by a stream id provided by the MPEG system encoding and sub stream id defined in the DVD. Accordingly, if a user selects one language, SPUs are extracted from only SP_PCKs having stream id and sub stream id corresponding to the selected language, then decoded, and subtitle data are extracted. Then, output is controlled according to display control commands.

Many problems arise from the fact that subtitle data are multiplexed together with video data as described above.

First, the amount of bits to be generated for sub picture data should be considered when video data are coded. That is, since subtitle data is converted into graphic data and processed, the amount of generated data for respective languages are different from each other and also the amounts are huge. Usually, after encoding of moving pictures is performed once, sub picture data for each language is again multiplexed being added to the output of the encoding such that a DVD appropriate to each region is produced. However, depending on the language, the amount of sub picture data is huge such that when sub picture data is multiplexed with video data, the entire amount of generated bits exceeds a maximum allowance. In addition, since sub picture data is multiplexed between video data, the start point of each VOBU is different according to the region. Since the start point of a VOBU is separately managed, whenever a multiplexing process newly begins, this information should be updated.

Secondly, since the contents of each sub picture cannot be known, sub picture data cannot be used for additional purposes, such as for outputting two languages at a time for a language by outputting only subtitle data.

### SUMMARY OF THE INVENTION

The present invention provides an information storage medium on which sub picture data is recorded with a data structure in which when video data are coded, the amount of bits to be generated for sub picture data need not be considered in advance and an apparatus therefor.

The present invention also provides an information storage medium on which sub picture data is recorded with a data structure in which sub picture data can be used for purposes other than subtitles and an apparatus therefor.

Additional aspects and/or advantages of the invention will be set forth in part in the description which follows and, in part, will be obvious from the description, or may be learned by practice of the invention.

According to an aspect of the present invention, there is provided an information storage medium on which video data are recorded, including: a plurality of clips that are recording units in which the video data are stored; and text data for subtitles which are recorded separately from the plurality of clips and overlappable with an image according to the video data and then outputtable, the text data including data for providing subtitles in at least one language.

The information storage medium may include character font data, which are recorded separately from the plurality of clips, for graphic expression of the text data and are which are usable in the text data.

When the text data is of multiple languages, the text data may be recorded in separate spaces for each of the multiple languages.

The text data may include character data which are convertible into graphic data and output synchronization information for synchronizing the graphic data with the video data.

The text data may include character data which are convertible into graphic data and output location information indicating a location in which the graphic data is to be displayed when the graphic data is overlapped with an image according to the video data.

The text data may include character data which are convertible into graphic data and information for expressing the output of the graphic data in a plurality of sizes when the graphic data is overlapped with an image.

The video data may be divided into units that are continuously reproducible, and a size of all of the text data corresponding to one unit is limited.

The video data may be divided into a plurality of units that are continuously reproducible, the text data corresponding to each reproducing unit being divided into a plurality of language sets, and a size of all of the text data forming one language set being limited.

The data forming the text data may be expressed and recorded in Unicode for supporting multi-language character sets.

When the text data for subtitles are formed only with characters of one of ASCII, which is a basic English character set, and ISO8859-1, which is a Latin-extended character set, the text data may be coded and recorded by using UTF-8 by which one character is coded into a plurality of 8-bit units.

When the text data includes a character having a code point value of a 2-byte size in Unicode, the text data may be coded and recorded by using UFT-16 by which one character is coded into a plurality of 16-bit units.

The information storage medium may be a removable type.

The information storage medium may be an optical disc which is readable by an optical apparatus of the reproducing apparatus.

According to another aspect of the present invention, there is provided a reproducing apparatus which reproduces data from an information storage medium on which video data is recoded, the video data being coded and divided into clips that are recording units and recorded in a plurality of clips and on which text data for subtitles that are formed with data of a plurality of languages and are overlappable as graphic data with an image based on the video data, the text data being recorded separately from the clips, the reproducing apparatus including: a data reproducing unit which reads data from the information storage medium; a decoder which decodes the coded video data; a renderer which converts the text data into graphic data; a blender which overlays the graphic data with the video data to generate an image; a first buffer which temporarily stores the video data; and a second buffer which stores the text data.

Font data may be stored in a third buffer and are usable in the text data for graphic expression of the text data and are recorded separately from the clips on the information storage medium, and the renderer converts the text data into graphic data using the font data.

When the text data are data of multiple languages, the text data may be recorded in separate spaces for each of the languages, wherein text data for a language that is one of selected by a user and set as an initial reproducing language s are temporarily stored in the second buffer, font data for converting the text data into graphic data may be temporarily stored in the third buffer, and, simultaneously, while reproducing video data, the text data may be converted into graphic data and the graphic data may be output.

The apparatus may include a controller which controls an output start time and end time of the text data using synchronization information. On the information storage medium may be recorded the text data which includes the synchronization information, by which the text data are converted into graphic data which are overlapped with an image based on the video data.

The apparatus may include a controller which controls a location where the text data is overlapped with an image based on the video data using output location information. On the information storage medium may be recorded the text data includes character data which are convertible into graphic data, and the output location information indicating a location where the graphic data is to be output when the graphic data is overlapped with an image based on the video data.

The video data recorded on the information storage medium may be divided into units that are continuously reproducible, and within a limited size of all of the text data corresponding to the recording unit, the text data are recorded. All of the text data whose size is limited may be stored in the second buffer before reproducing the continuously reproducible units, and when a language change occurs during reproduction, subtitle data corresponding to the language stored in the buffer may be output.

The video data may be divided into units that are continuously reproducible, the text data corresponding to one unit are divided into a plurality of language sets, the text data for subtitles forming the one language set are recorded so that all of the text data is limited. The text data corresponding to a language set containing the subtitle data which are output simultaneously with video data, may be stored in the buffer before reproducing the unit that is continuously reproducible, and when a language change occurs during reproduction, when the text data for the language are in the buffer, the text data for the language may be output, and when the text data for the language are not in the buffer, the text data corresponding to the language set containing the text data for the language are stored in the buffer and the text data for the language may be output.

The apparatus may include a subtitle size selector which selects a size of the subtitle data based on a user input. The text data may include character data, which are convertible into graphic data, and information indicating the output of a plurality of graphic data items when the graphic data is overlapped with an image based on the video data may be recorded on the information storage medium.

Data forming the text data may be expressed and recorded in Unicode for supporting multi-language sets, and the renderer converts the characters expressed in Unicode into graphic data.

On the information storage medium, when the text data for subtitles are formed only with characters of one of ASCII, which is a basic English character set, and ISO8859-1, which is a Latin-extended character set, the text data may be coded and recorded by using UTF-8 by which one character is coded into a plurality of 8-bit units, and the renderer may convert the characters expressed by UFT-8 into graphic data.

On the information storage medium, when the text data includes a character having a code point value of a 2-byte size in Unicode, the text data may be coded and recorded by using UFT-16 by which one character is coded into a plurality of 16-bit units, and the renderer may convert the characters expressed by UTF-16 into graphic data.

The information storage medium may be a removable type, and the reproducing apparatus may reproduce data recorded on the removable information storage medium.

The information storage medium may be an optical disc which is readable by an optical apparatus of the reproducing apparatus, and the reproducing apparatus may reproduce data recorded on the optical disc.

The reproducing apparatus may output the graphic data without reproducing video data recorded on the information storage medium.

The subtitle data may include subtitle data for one or more languages and the renderer may convert text data for the one or more languages into graphic data.

The subtitle data may be synchronously overlapped with a video image and then output.

According to still another aspect of the present invention, there is provided A recording apparatus which records video data on an information storage medium, including: a data writer which writes data on the information storage medium; an encoder which codes video data; a subtitle generator which generates subtitle data addable to the video data; a central processing unit (CPU); a fixed-type storage; and a buffer. The video data is stored in the fixed-type storage after the encoder divides video images into clips that are recording units and compression encodes the clips. The subtitle generator generates subtitle data for a plurality of languages in the form of a text, the subtitle data being reproducible together with an image based on the video data and stored in the fixed-type storage. The buffer temporarily stores the data stored in the fixed-type storage. The data writer records the coded video data and subtitle data that are temporarily stored in the buffer on the information storage medium. The CPU controls encoding of the video data, recording the coded video data and the subtitle data in respective separate areas on the information storage medium.

The apparatus may include a font data generator which generates font data for converting text data for subtitles into graphic data. The font data generator may generate font data needed for converting the subtitle data into graphic data, and may store the font data in the fixed-type storage. The buffer may temporarily store the font data stored in the fixed-type storage, the data writer may record the font data temporarily stored in the fixed-type storage on the information storage medium, and the CPU may control the generating of the font data and recording the font data in separate areas of the information storage medium.

When the text data are data of multiple languages, the CPU may control the subtitle data so that the subtitle data are recorded in a separate space for each language.

The apparatus may include a subtitle generator which generates the subtitle data by including character data which are convertible into graphic data and then output and output synchronization information for synchronizing with reproduction of the video images.

The subtitle generator may generate the subtitle data by including character data which are convertible into graphic data and may output location information indicating a location where the graphic data will be output when the graphic data is overlapped with an image based on the video data.

The subtitle generator may generate the text data by including character data which is convertible into graphic data and information for expressing the output of the graphic data with a plurality of sizes when the graphic data is overlapped with an image based on the video data.

The coded video data may be divided into recording units that are continuously reproducible, and the subtitle generator may generate the text data so that a size of all of the subtitle data corresponding to the recording unit is limited.

The coded video data may be divided into recording units that are continuously reproducible, and after the text data corresponding to the recording unit are divided into a plurality of language sets, the subtitle generator may generate the text data so that a size of the entire subtitle data forming the one language set is limited.

The subtitle generator may generate data forming the text data in Unicode for supporting multi-language character sets.

The encoder may encode by using UTF-8 by which one character is coded into a plurality of 8-bit units when the text data are formed only with characters of one of ASCII, which is a basic English character set, and ISO8859-1, which is a Latin-extended character set.

The encoder encodes by using UFT-16 by which one character is coded into a plurality of 16-bit units when the text data includes a character having a code point value of a 2-byte size in Unicode.

The information storage medium may be a removable type.

The information storage medium may be an optical disc.

According to yet another aspect of the present invention, there is provided a method of reproducing data stored on an information storage medium, including: reading audio-visual (AV) data and text data; rendering subtitle image data from the text data; decoding the AV data and outputting decoded AV data; and blending the subtitle image data and the decoded AV data.

According to still another aspect of the present invention, there is provided a reproducing apparatus including: a reading section which reads audio-visual (AV) data, text data, and font data; a decoder section which decodes the AV data and outputs moving picture data; a rendering section which renders subtitle image data from the text data; and a blending section which synthesizes the moving picture data with the subtitle image data.

According to yet another aspect of the present invention, there is provided a reproducing apparatus including: a reading section which reads text data and font data; a rendering section which renders subtitle image data from the text data; and an outputting section which outputs the subtitle image data an input receiving section which receives an input to subtitle data for a next line so as to control the output time of the subtitle data.

According to yet another aspect of the present invention, there is provided a data recording and/or reproducing apparatus including: a storage section; an encoder which codes audio-visual (AV) data to yield coded AV data; a subtitle generator which generates renderable text data for subtitles; a data writer which writes the coded AV data and the renderable text data onto the storage section; a reading section which reads the coded AV data and the rederable text data; a decoder section which decodes the coded AV data so as to yield moving picture data; a rendering section which renders subtitle image data from the renderable text data; and a blending section which synthesizes the moving picture data with the subtitle image data so as to yield blended moving picture data.

To achieve the above and/or aspects and advantages, on an information storage medium according to various embodiments of the present invention, each subtitle data item is not coded together with AV data and within AV data, but is recorded in the form of separate text data in a separate recording space. In addition, on the information storage medium, separate font data for rendering subtitle data that is in the form of text data is recorded. Also, synchronization information for interlocking subtitle data with AV moving pictures for which decoding process is finished, and output information for screen output are recorded. The subtitle data corresponds to sub picture data in the conventional DVD. That is, on the information storage medium according to various embodiments of the present invention, the following elements are recorded:

1) AV data (clip) into which video information is compression encoded;

2) text data for multi-language subtitles; and

3) font data for rendering text data.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a data structure for a DVD;

FIG. 2 is a detailed diagram of a VMG area;

FIG. 3 is a detailed diagram of a VTS area;

FIG. 4 is a detailed diagram of a VOBS that is video data;

FIG. 5 is a diagram showing the relation between an SPU and SP_PCK;

FIG. 6 is a diagram of the data structure of a sub picture when it is encoded;

FIG. 7 is a diagram of the data structure of SP_DCSQT;

FIG. 8 is a reference diagram showing an output situation with sub picture data considered;

FIG. 9 is a block diagram of a reproducing apparatus according to an embodiment of the present invention;

FIG. 10 is a diagram of the data structure of text data stored in an information storage medium according to an embodiment of the present invention;

FIG. 11 is an embodiment of text data for subtitles according to an embodiment of the present invention;

FIG. 12 is a diagram of the data structure of text data for a language other than the language of FIG. 11;

FIG. 13 is an example of a text file used in the present invention;

FIG. 14 is an example of a subtitle to which a different style is applied;

FIG. 15 is an example of a subtitle displayed after changing a line;

FIG. 16 is an example showing a case where a user executes a language change while subtitles in a language are being reproduced;

FIG. 17 is an example of a plurality of language sets of subtitle data and font data for multiple languages;

FIG. 18 is a diagram showing correlations of PlayList, PlayItem, clip information, and a clip;

FIG. 19 is an example of a directory structure according to the present invention;

FIG. 20 is an example showing a case where a reproducing apparatus outputs only subtitle data;

FIG. 21 is an example showing a case where a reproducing apparatus outputs subtitle data for more than one language at the same time;

FIG. 22 is an example showing a case where during reproduction of only subtitle data, normal reproduction of video data begins from video data corresponding to subtitle line data; and

FIG. 23 is a block diagram of a recording apparatus according to an embodiment of the present invention.

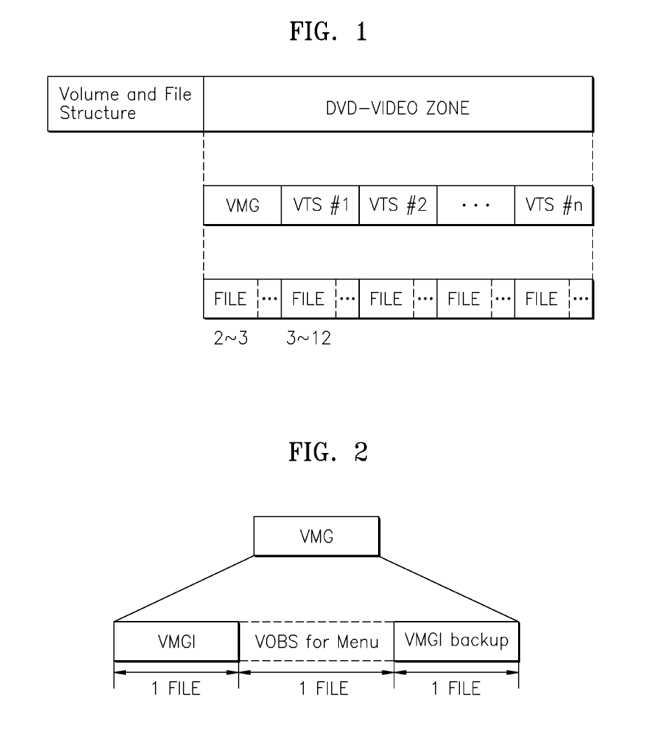

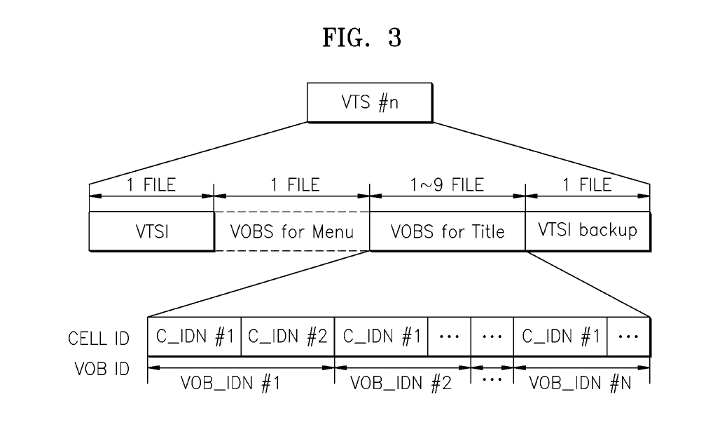

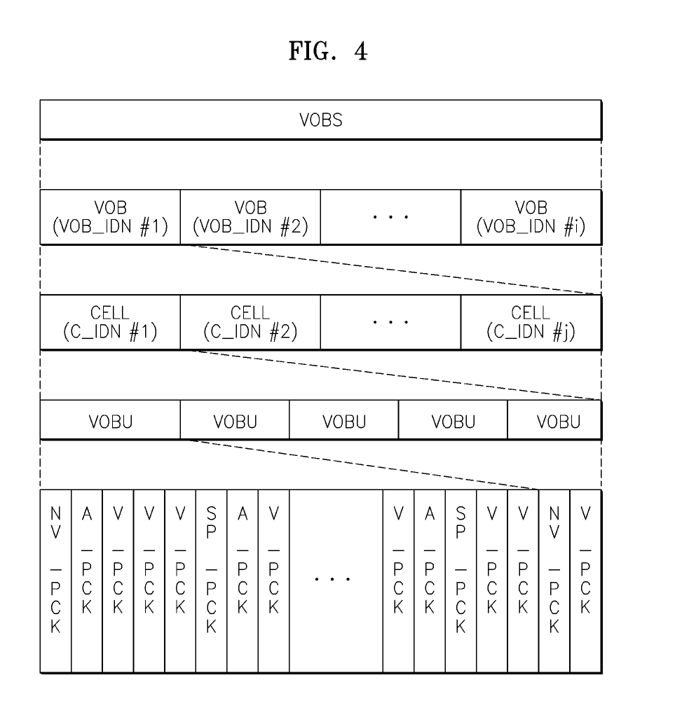

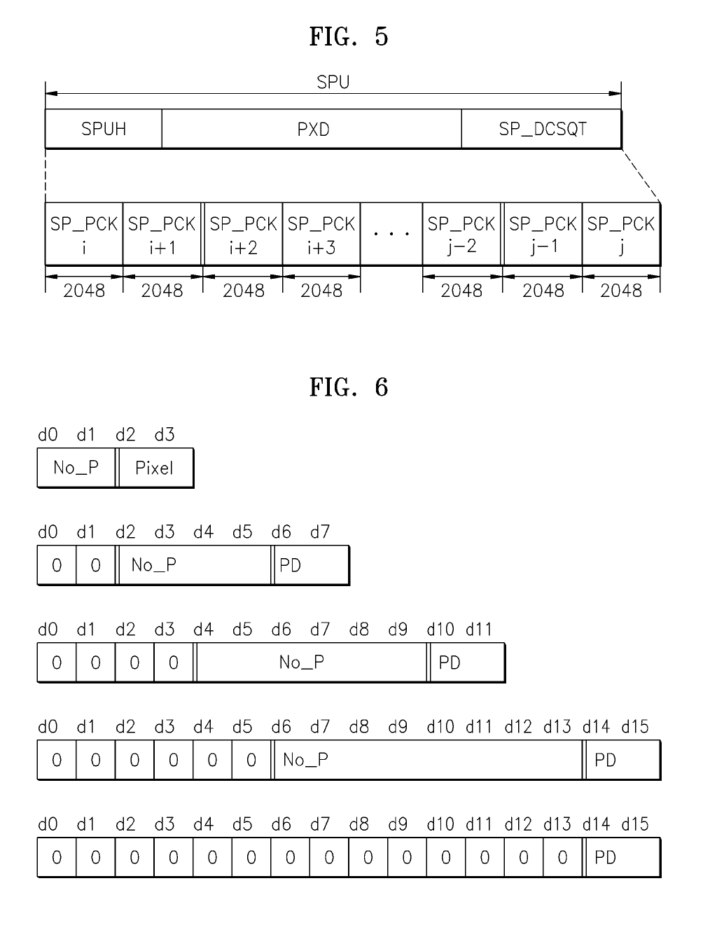

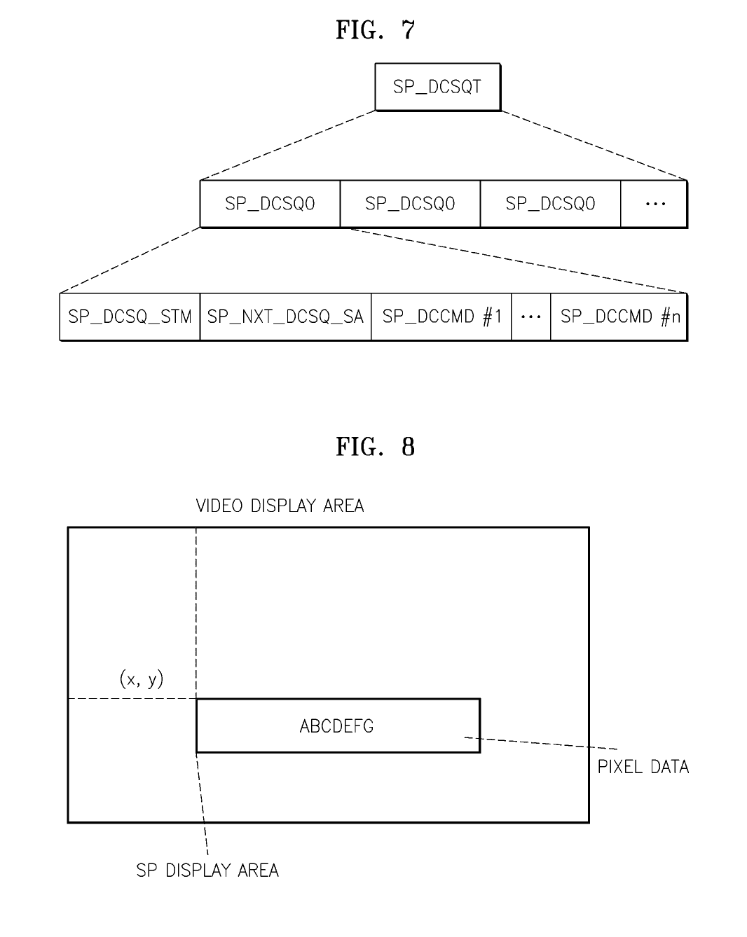

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

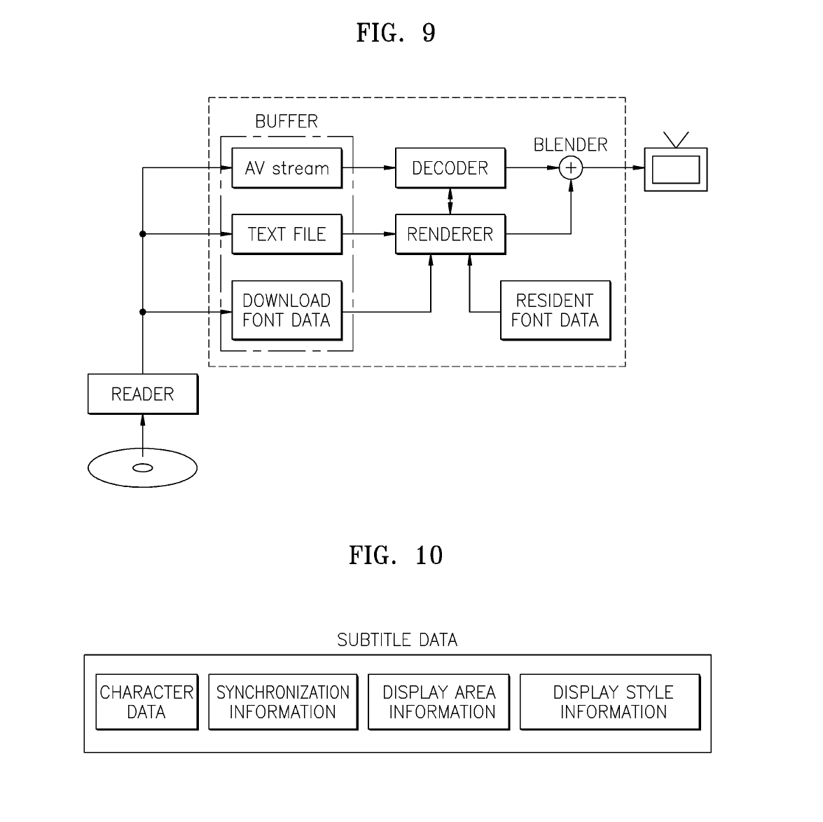

FIG. 9 is a block diagram of a reproducing apparatus according to an embodiment of the present invention.

Referring to FIG. 9, the reproducing apparatus includes a reader which reads AV data, text data for subtitles, and downloaded font data stored in an information storage medium, a decoder for decoding AV data, a renderer which renders text files, and a blender which synthesizes moving pictures output from the decoder with subtitle data output from the renderer.

In addition, the reproducing apparatus further includes a buffer, which buffers data between the reader and the decoder and renderer s and stores determined font data, and may further include a storage (not shown) for storing resident font data that are stored in advance as defaults.

As used herein, rendering encompasses all needed activities related to converting subtitle text data into graphic data so as to be displayed on a display apparatus. That is, rendering includes producing graphic data to form a subtitle image by repeating the process for finding a font matching with the character code of each character in the text data in the downloaded font data read from the information storage medium or from the residing font data, and converting the font data into graphic data. Rendering also includes selecting or converting colors, selecting or converting the size of characters, and producing graphic data appropriate to writing in horizontal lines or vertical lines. In particular, when the font data being used is an outline font, font data defines the shape of each character as a curve formula. In this case, rendering also includes a rasterizing process for generating graphic data by processing the curve formula.

FIG. 10 is a diagram of the data structure of text data (i.e., subtitle data) stored in an information storage medium according to an embodiment of the present invention.

Referring to FIG. 10, text data is recorded separately from AV streams. The text data includes synchronization information, display area information, and display style box information. The synchronization information is addable to data to be output with subtitles in a rendering process and is usable for synchronizing the subtitles with video information which is decoded from AV stream data. The display area information designates a location on which rendered subtitle data are displayed on a screen. Display style box information contains information on the size of characters, writing of rendered subtitle data in horizontal lines or in vertical lines, and arrangement, colors, contrast, etc., in a display area. In addition, since text data for each of a plurality of languages may be written, the text data also contains information indicating a language of the plurality of languages. This so-called multi-language data may be stored in separate spaces for each of the respective languages, or may be stored in one space after being multiplexed in order of output time.

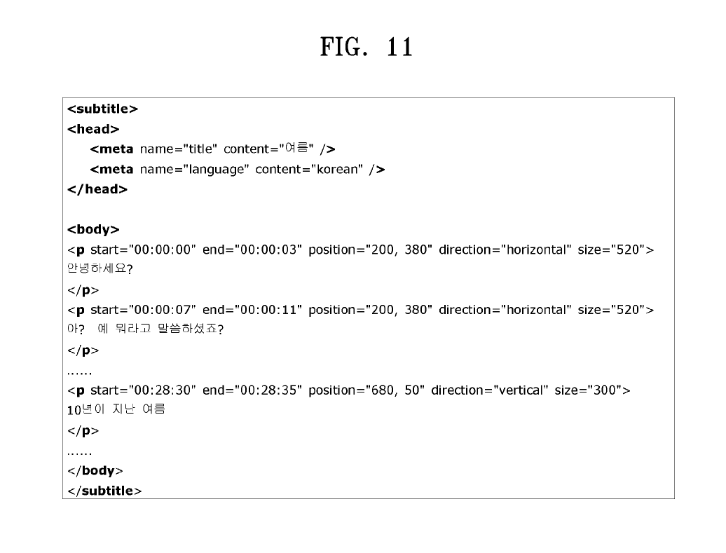

FIG. 11 is illustrates text data for subtitles according to an embodiment of the present invention.

Referring to FIG. 11, a markup language is used as text data for subtitles in the present embodiment. Considering that the purpose of use is for subtitles, a minimal number of tags or elements in the markup language used for subtitles are used, and as described above, tags or attributes for synchronization and screen display may be included. Here, subtitle, head, meta, body, p elements are shown as examples. In the present embodiment, information is displayed with an attribute. Attributes used in the example are as follows:
start: A time at which subtitle data corresponding to moving pictures should be output when the start time of the moving pictures that should be reproduced together with the subtitle data is set to 0. A time at which subtitles are displayed is expressed in the form of time (HH): minute (MM): second (SS): frame (FF). The time can be expressed in units of 1/1000 second. Also, if video data is MPEG video, the time may have a presentation time stamp (PTS) value of video images on which the subtitle overlays and is displayed. Generally, the PTS value is a count value operating at 27 MHz or 90 kHz. If the PTS value is used, the subtitle data can be accurately matched with video data and operated.
end: A time at which a displayed subtitle disappears and has the same type of attribute value as ‘start’.
position: This indicates the coordinates of the top left-hand vertex in a video area in a display area in which subtitle data is to be displayed.
direction: This indicates the direction of subtitle data to be displayed.
size: This indicates the width or height of a display area in which subtitle data is to be displayed. If the attribute value of “direction” is “horizontal”, a fixed width value of a subtitle data box is indicated, and if “vertical”, a fixed height value of the subtitle data box is indicated.

Among used elements, a subtitle element is used to indicate the root of text data, and a head element is used to include a meta element which deals with information needed by all of the text data, or a style element which is not shown in the example of FIG. 11. In the present embodiment, a meta element is used to express the title of the corresponding text data and the language to be used. That is, when multiple languages are selected, by using meta information in the text data, a desired language text file can be conveniently selected. Also, languages can be distinguished by the names of text files, or by directory names, if a different directory for each language text file is prepared.

Thus stored subtitle data is loaded into the buffer of the reproducing apparatus before video data is reproduced, and with the reproduction of video data, the subtitle data is converted into graphic data by the renderer and made to overlap video images. Accordingly, the subtitle data in, for example, Korean, is displayed in a display area at an exact time. As described above, for the text data, in addition to the subtitle character data, control information may also be written in a format or syntax. Accordingly, the renderer has a parser function for verifying that a text file to be stored is written according to a syntax. Also, in order to synchronize the subtitle data with video images decoded by the decoder by using the synchronization information included in the text file, there is a channel through which events for sending or determining information on the reproducing time and the reproducing state of the decoder are exchanged with the decoder.

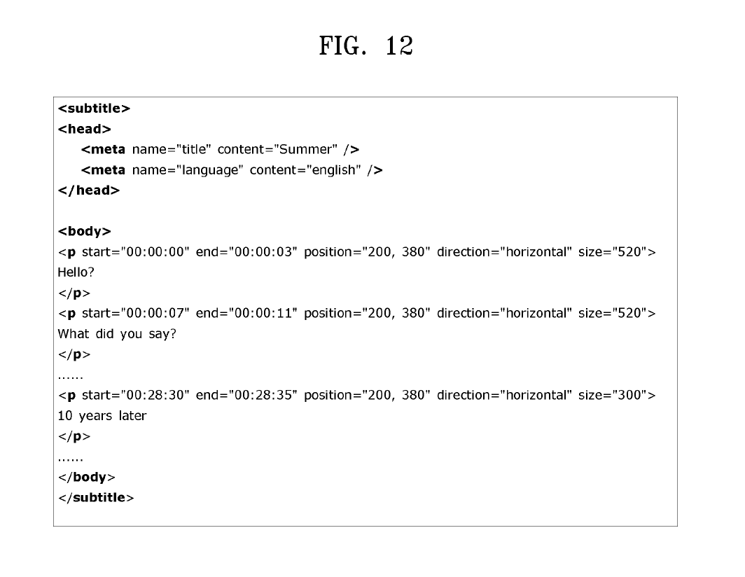

FIG. 12 is a diagram of the data structure of text data for a language other than the Korean language of FIG. 11.

Referring to FIG. 12, when video data and text data are recorded in different areas, support for multiple languages is achievable by coding the video data separately from the subtitle data and then adding text data of respective different languages to the coded video data. Also, when subtitle data and font data that are not stored with video data on the information storage medium are downloaded through networks or loaded on the reproducing apparatus from an additional information storage medium, thus, subtitle data is easily used in other cases.

When multiple languages are thus supported, a character code to be used for the text data should be determined. In an embodiment, Unicode is used. Unicode is a character code made to express languages throughout the world with more than 65,000 characters. According to the Unicode, each character is expressed by a code point in Unicode. Characters to express respective languages are sets of code points having regularly continuous values. The characters having a continuous space of code points are referred to as a code chart. Also, Unicode supports UTF-8, UTF-16, and UTF-32 as coding formats for actually storing or transmitting character data, that is, the code points. These formats are to express one character by using a plurality of data items with an 8-bit length, 16-bit length, and 32-bit length, respectively.

An ASCII code for expressing English characters and an ISO8859-1 code for expressing languages of European countries by expanding Latin have code point values from 0x00 to 0xFF in Unicode. Japanese Hirakana characters have code point values from 0x3040 to 0x309F. The 11,172 characters for expressing modern Korean have code point values from 0xAC00 to 0XD7AF. Here, 0x indicates that the code point value is expressed by hexadecimal numbers.

If subtitle data includes only English characters, the coding is performed by using UTF-8. For Korean or Japanese subtitle data, if UTF-8 is used, one character is expressible using 3 bytes. If UTF-18 is used, one character is expressible in 2 bytes but each of the English characters included in the subtitle data at is also expressible in 2 bytes.

Each country has its own character code different from Unicode. For example, in the Korean character code set, KSC5601, a Korean character has a 2-byte code point value and an English character has 1-byte code point value. If the subtitle data is generated by using a code other than Unicode but each nation's character set, each reproducing apparatus understands all of these character sets such that the load for implementation increases.

Font data is needed in order to process subtitle data as text data. Also, in order to support multiple languages, the font data supports multiple languages. However, it is difficult to manufacture all reproducing apparatuses having these fonts that support multiple languages. Accordingly, in this embodiment of the present invention, font data only for the characters used in an information storage medium are recorded in the information storage medium as subtitle data such that in a reproducing apparatus, such font data is loaded into a buffer before reproducing video data and then used. That is, the reproducing apparatus links each piece of subtitle text data with font data and then reproduces the data. Link information of subtitle text data and font data is recorded in the text data for subtitles or in a separate area. Considering a case where a user executes a language change during reproduction of data, the reproducing apparatus loads subtitle data and font data, which correspond to video data and is continuously reproducible before reproduction, and then uses the data. Here, continuous reproduction encompasses reproduction without pause, cessation, or interruption in the video and audio outputs of the video data. Generally, a reproducing apparatus reproduces data by storing an amount of data in a video and audio buffer and if underflow in the buffer of the reproducing apparatus is prevented, continuous reproduction is possible. When subtitles or font data corresponding to video data are read again through the reader in order to change subtitles during reproduction, if underflow of the video and audio data does not occur during the time, loading in advance may not be needed.

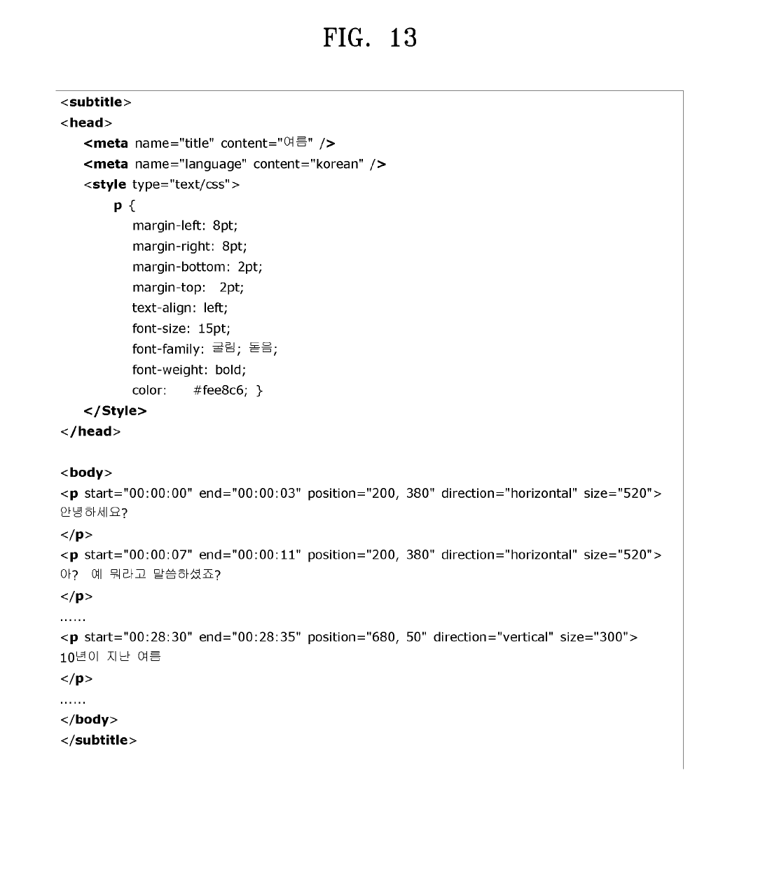

FIG. 13 is an example of a text file used in this embodiment of the present invention.

Referring to FIG. 13, in this embodiment of the present embodiment, a style element is used in a head element in order to use a Cascade Style Sheet (CSS) file format as an application of a style in a markup language for implementing a text file. By using CSS, subtitle data can use a variety of fonts with different sizes and colors.

In some applications or with some users, subtitle styles that are set as defaults are not convenient. For example, a person with bad eyesight may feel inconvenience if the size of the font of the subtitle text is small. Accordingly, it is desirable to apply and display a style to satisfy ordinary users or persons with bad eyesight when applied to an identical text file. Therefore, by allowing users to determine the style, such as the size of a font, through a menu when reproducing an information storage medium in a first reproducing apparatus, a style sheet which is for applying a style according to a user's settings and has a plurality of options that are selectable by the user can be used.

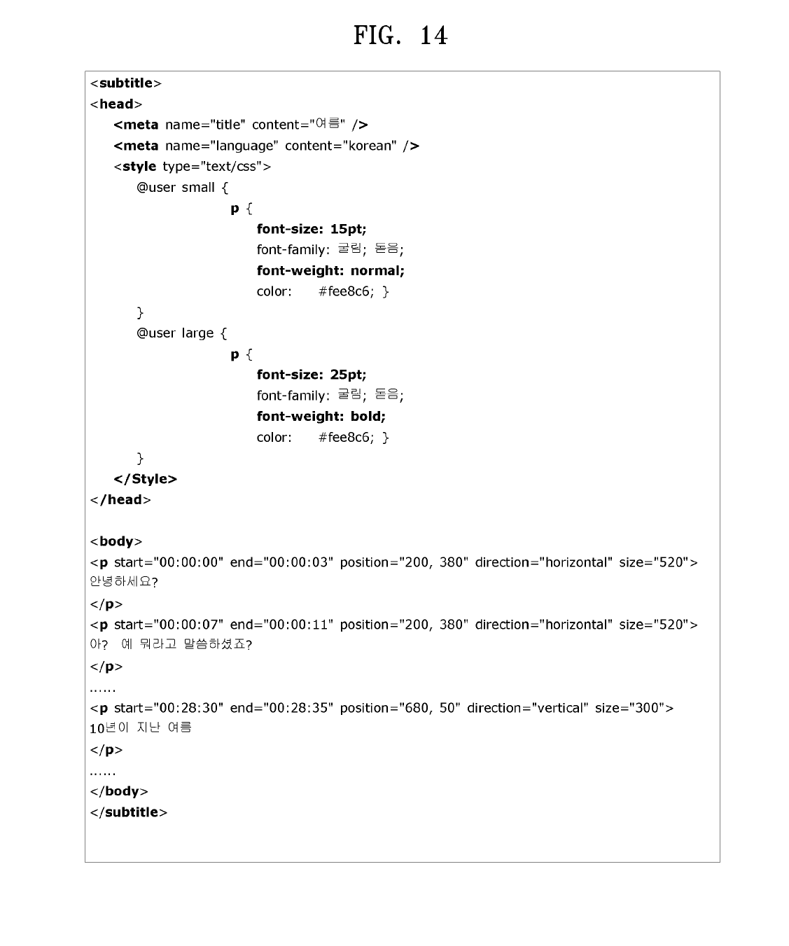

In the present invention, an @user rule by which a subtitle style according to a user is settable will now be explained. User type is a set of CSS attributes. In the present embodiment, a detailed distinction of user types, that is, the degree of bad eyesight, is not relevant, and therefore, only the two following cases as follows will be explained:
small: a style for a user with normal eyesight; and
large: a style for a user with bad eyesight As shown in FIG. 14, subtitles which are preset by using an @user rule or to which different styles are applied for users with good eyesight or with bad eyesight can be displayed.

It is also possible for a reproducing apparatus to output subtitles with applying a different position and size according to the user's preference without using the position and size determined by the subtitle data.

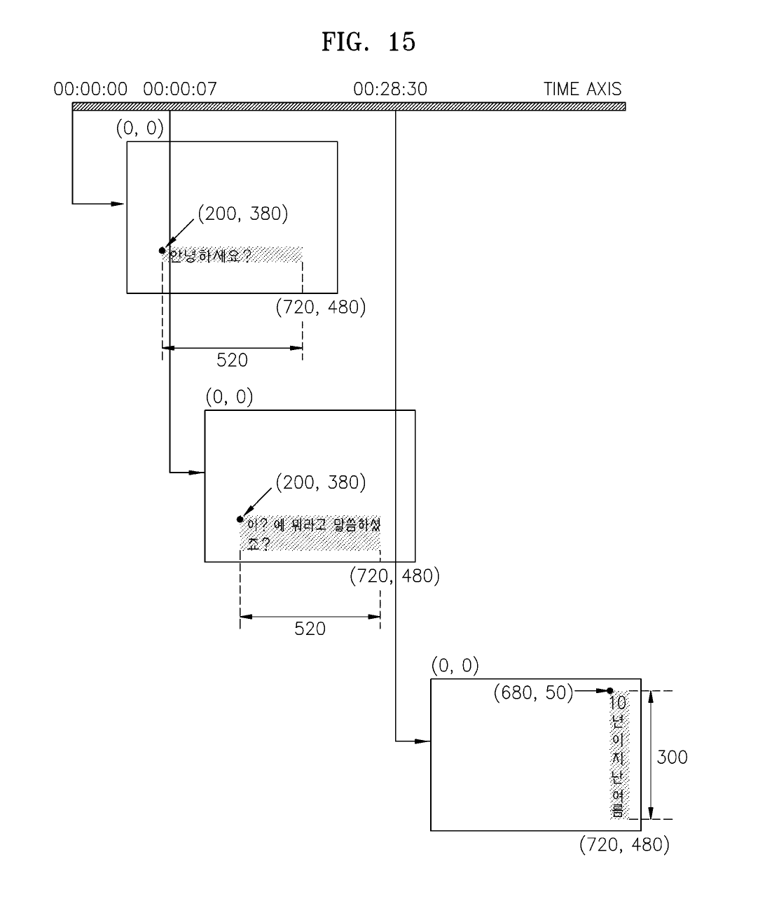

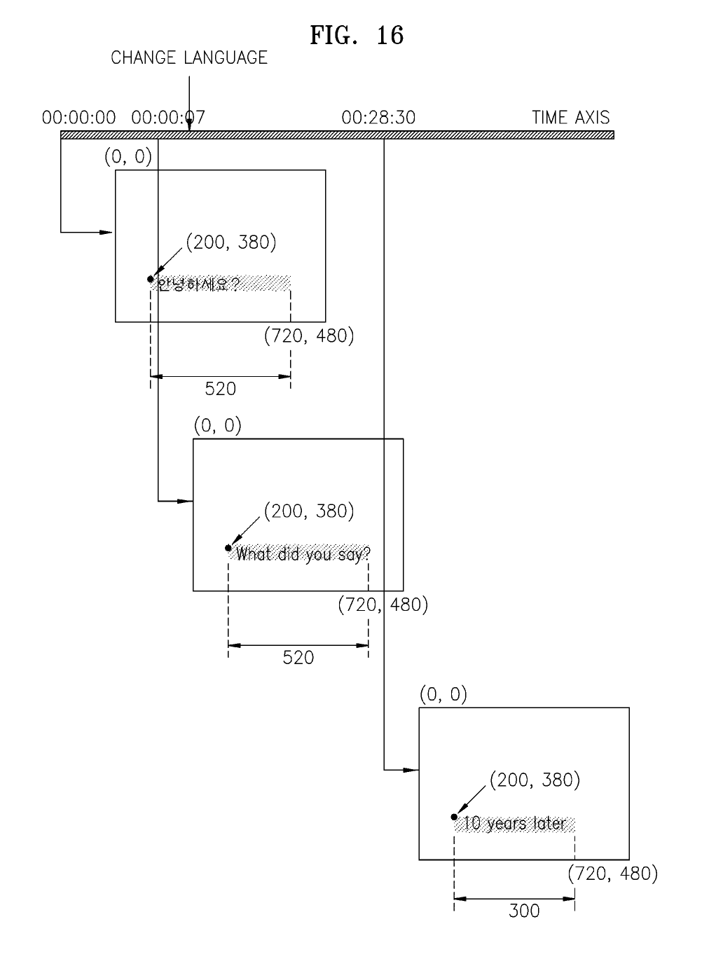

FIG. 15 is an example in which the text data for the Korean subtitles implemented in FIG. 11 are displayed on an actual screen.

Referring to FIG. 15, since in the screen expressed by the second <p> element, the width value of the subtitle data display area is fixed to 520 by the “size” attribute, subtitle data that cannot be expressed within one line is displayed after changing a line. Alternatively, subtitle data is outputtable only in a display area and by using a line change element (br), line change can be selected forcibly.

The third <p> element is an example in which by a “direction” attribute, the display of subtitle data is vertically performed.

FIG. 16 is an example showing a case where a user executes a language change while subtitles in a language are being reproduced.

Referring to FIG. 16, when a language change is needed, a reproducing apparatus changes subtitle text data being reproduced (in Korean, for example), links font data corresponding to text data, renders data of the changed language (English, for example), and by doing so, outputs the subtitles. If data for subtitles and font data for this are all loaded in the buffer, continuous reproduction of video data can be easily performed. If text data or font data desired to be changed is not loaded in the buffer, the data should be loaded into the buffer. At this time, a pause, cessation, or interruption can occur in reproduction of video data.

For multi-language conversion without pause, cessation, or interruption of video reproduction, the sizes of data for subtitles and font data are limitable to less than the sizes of the respective buffers. In this case, however, the number of supported languages is restricted. Accordingly, in the present embodiment of the present invention, this problem is solved by creating a unit referred to as a language set.

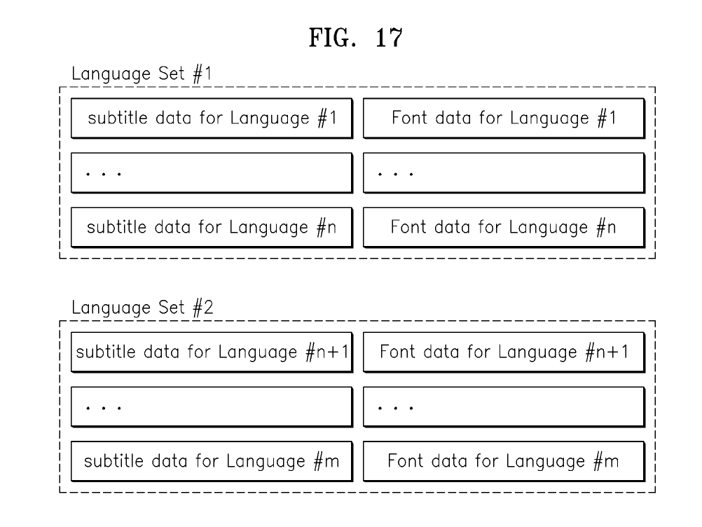

FIG. 17 is an example of a plurality of language sets of subtitle data and font data for multiple languages.

Referring to FIG. 17, subtitle data and font data for a plurality of languages added to one video image are divided into a plurality of language sets. Subtitle data and font data that correspond to one language set are limited to a size that is less than the size of the buffer. After a language set containing subtitle data of a language selected by a user or selected as a default by the reproducing apparatus is loaded in the buffer before reproducing video data, reproducing video data begins. When the user executes a language change, the language change with the subtitle data included in this language set can be done without cease because the data is already loaded in the buffer. However, if a change to a language not included in this language set is made, the reproducing apparatus loads again the subtitle data and font data of the desired language set. In this case, data of the existing language set is all deleted. At this time, in reproducing video data, a pause, cessation, or interruption may occur. Thereafter, if a language change is performed, a language change operation is performed again according to the relation between the language and the language set loaded in the buffer. Information on the language set is recordable on an information storage medium or by considering the data stored in an information storage medium and the size of the buffer in the reproducing apparatus, and the reproducing apparatus determines this arbitrarily when reproducing data.

The relation between information needed in reproducing video data and the subtitle data will now be explained with an embodiment.

As used herein, a clip is a recording unit of video data, and PlayList and PlayItem will be used to indicate reproducing units.

In an information storage medium according to an embodiment of the present invention, AV streams are separated and recorded in units of clips. Usually, a clip is recorded in a continuous space. In order to reduce the volume, AV streams are compressed and recorded. Accordingly, in order to reproduce the compressed AV streams, attribute information of the compressed video data should be informed. Therefore, Clip information is recorded in each clip. Clip information contains audio video attributes of the clip and an Entry Point Map in which information on the location of an Entry Point where random access is available in each interval is recorded. In an MPEG, which is widely used as a video compression technology, the Entry Point is the location of I picture where an intra image is compressed, and the Entry Point Map is mainly used for a time search used to find a point in a time interval after the starting point of reproduction.

PlayList is a basic unit of reproduction. In an information storage medium according to the present embodiment, a plurality of PlayLists is stored. One PlayList includes a series of a plurality of PlayItems. PlayItem corresponds to a part of a clip, and more specifically, it is used in the form by which a reproduction start time and end time in the clip are determined. Accordingly, by using Clip information, the location of the part in an actual clip corresponding to the PlayItem is identified.

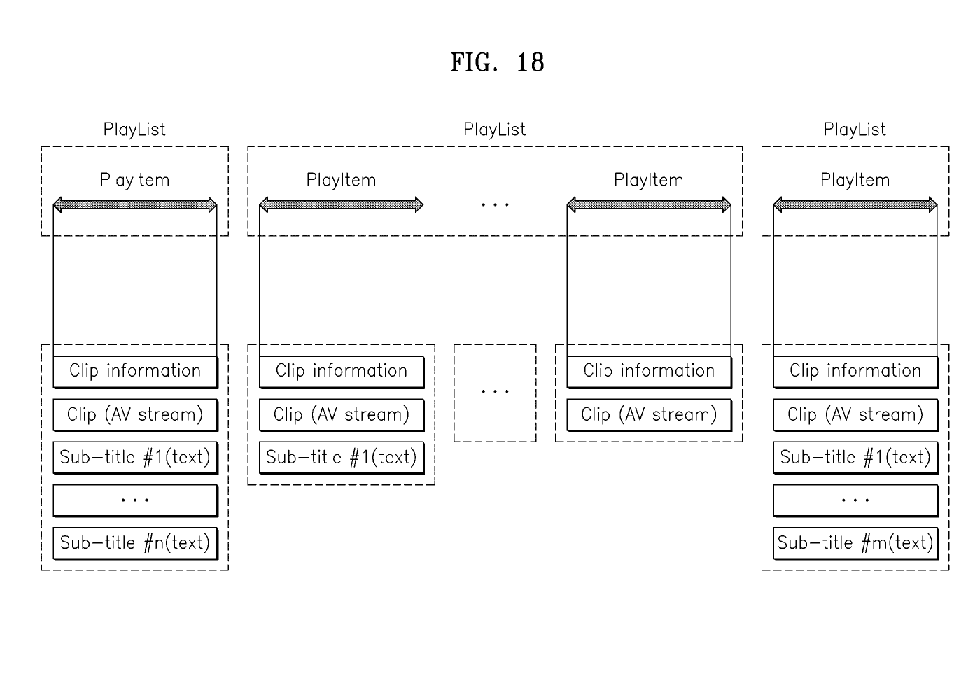

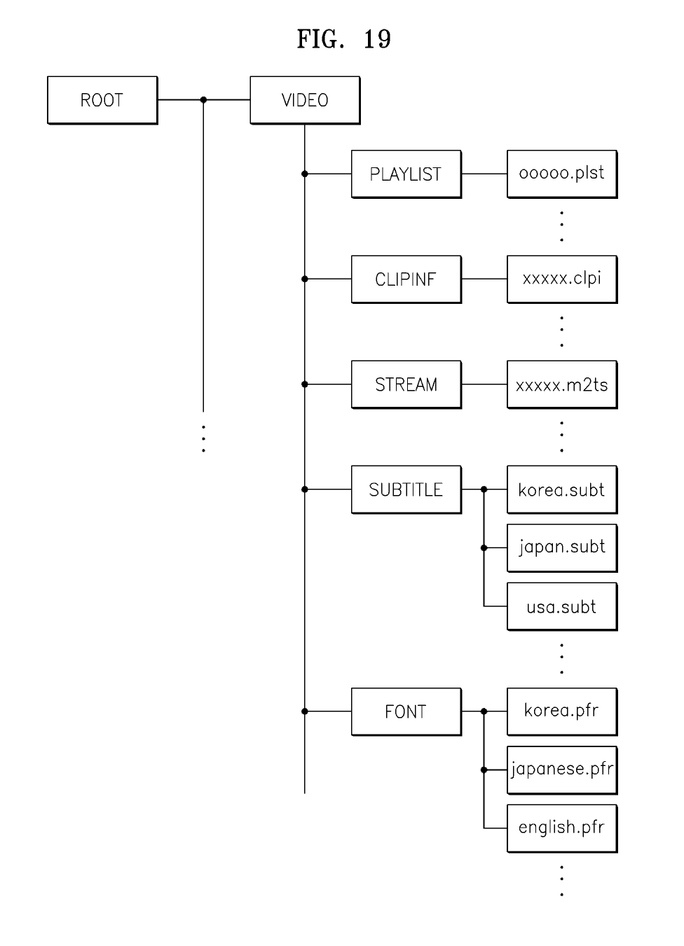

FIG. 18 is a diagram showing correlations of a PlayList, a PlayItem, Clip information, and a clip.

Referring to FIG. 18, in addition to a PlayList, a PlayItem, Clip information, and a clip, in the present embodiment of the present invention, a plurality of text data items for subtitles for each clip are recorded in a space separate from the clip. A plurality of data items for subtitles are linked to one clip and this link information is recordable in the Clip information. To some clips, a plurality of data items for subtitles are linked, but for some clips, no data items or only one data item for subtitles may be linked. When PlayList is reproduced, PlayItems included in the PlayList are sequentially reproduced. As a result, any one of the clips linked to each PlayItem and a plurality of subtitles linked to the clip are rendered and output. Since continuous reproduction between PlayLists is usually not guaranteed, all linked text data for subtitles is loadable into a buffer before reproducing the PlayList. In FIG. 18, font data is not separately marked.

Usually, font data is generated for each language. Accordingly, font data is recorded in a separate space for each language.

FIG. 19 is an example of a directory structure according to an embodiment of the present invention.

Referring to FIG. 19, in a directory, clip, Clip information, a PlayList, subtitle text data, and font data are stored in the form of files and stored in different directory spaces according to the respective types. As shown, text files for subtitles and font files are storable in directory spaces separate from video data.

An information storage medium according to various embodiments of the present invention is a removable information storage medium (i.e., one which is not fixed to a reproducing apparatus and, only when data is reproduced, can be placed and used). Unlike a fixed information storage medium with a high capacity such as a hard disc, the removable information storage medium has a limited capacity. Also, reproducing apparatuses for reproducing this medium often have a buffer with a limited size and low level function s with limited performance. Accordingly, together with video data recorded on a removable information storage medium, only subtitle data and font data used for the subtitle data are recorded on the information storage medium and by using the data when video data is reproduced from the information storage medium, the amount of data that should be prepared in advance can be minimized. A representative example of this removable recording medium is an optical disc.

On an information storage medium according to an embodiment of the present invention, video data is stored in a space separate from subtitle text data. If this subtitle text data is for multiple languages and has font data for outputting the subtitle data, a reproducing apparatus loads only the subtitle data and font data in the buffer and then, while reproducing video data, overlaps the subtitle data with a video image and outputs the subtitle data.

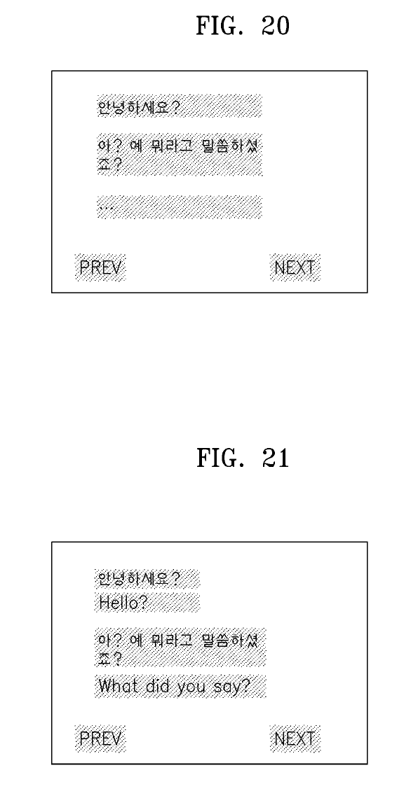

FIG. 20 is an example showing a case where a reproducing apparatus outputs only subtitle data.

Referring to FIG. 20, a reproducing apparatus according to an embodiment of the present invention may output only subtitle data. That is, according to one of the many special reproduction functions, video data is not reproduced, and only subtitle data that is to be output overlapping the video data is converted into graphic data and then output. In this case, subtitle data may be used, for example, for learning a foreign language. Here, video data is not overlapped and only subtitle data is output. Also, both the synchronization information and location information are neglected or not included, and the reproducing apparatus outputs a plurality of line data items including subtitle data on the entire screen, and waits for a user input. After watching all of the output subtitle data, the user sends a signal for displaying subtitle data for the next line to the reproducing apparatus so as to control the output time of the subtitle data.

FIG. 21 is an example showing a case where a reproducing apparatus outputs subtitle data for more than one language at the same time.

Referring to FIG. 21, as an embodiment, a reproducing apparatus may have a function for outputting subtitle data for two or more languages at the same time when subtitle data includes a plurality of languages. At this time, by using synchronization information of subtitle data for each language, subtitle data to be displayed on the screen is selected. That is, subtitle data is output in order of output start time, and when the output start times are the same, the subtitle data is output according to language.

A function, by which while only subtitle data are reproduced, normal reproduction of video data can be started from the video data corresponding to a subtitle line data item, is also implementable.

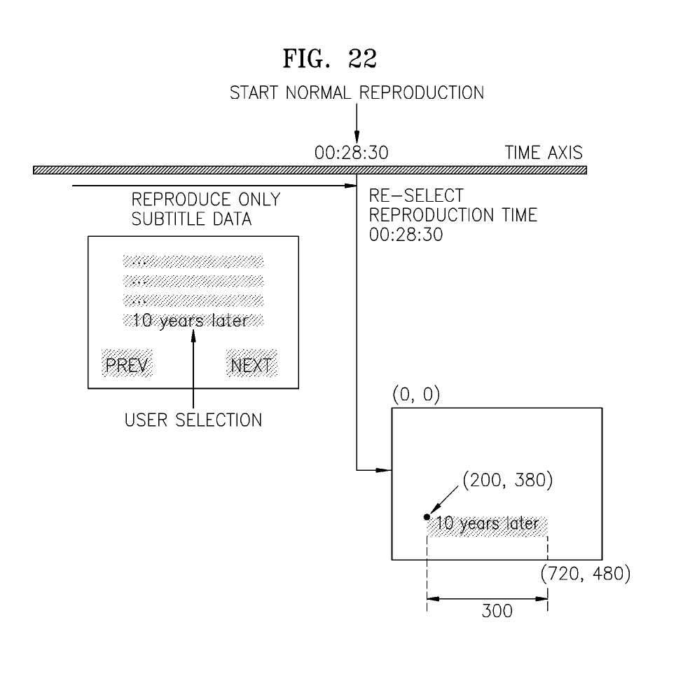

FIG. 22 is an example showing a case where during reproduction of only subtitle data, normal reproduction of video data begins from video data corresponding to subtitle line data.

As shown in FIG. 22, when the user selects one subtitle line data item, a reproducing time corresponding to the line data item is selected again, and video data corresponding to the time is normally reproduced.

A recording apparatus according to an embodiment of the present invention records video data and subtitle data on an information storage medium.

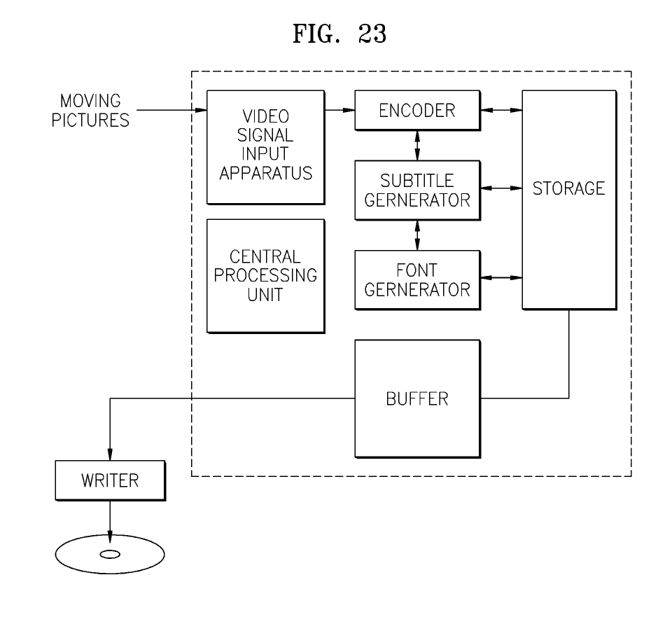

FIG. 23 is a block diagram of a recording apparatus according to an embodiment of the present invention.

Referring to FIG. 23, the recording apparatus includes a central processing unit (CPU), a fixed high-capacity storage, an encoder, a subtitle generator, a font generator, a writer, and a buffer.

The encoder, subtitle generator, and font generator may be implemented by software on the CPU.

In addition, a video input unit for receiving video data in real time is also includable.

The storage stores a video image that is the object of encoding, or video data that is coded by the encoder. In addition, the storage stores a dialogue attached to the video data and large volume font data. The subtitle generator receives information on the output time of a subtitle line data item from the encoder, receives subtitle line data from the dialogue data, makes subtitle data for the subtitles, and stores the subtitle data in a fixed-type storage apparatus. The font generator generates font data containing characters used in the subtitle data for subtitles from the large volume font data and stores the font data in the fixed-type storage apparatus. That is, the font data stored in the information storage medium is part of the large volume font data stored in the fixed-type storage apparatus. This process for generating data in the form to be stored in an information storage medium is referred to as authoring.

If the authoring process is finished, coded video data stored in the fixed-type storage apparatus are divided into clips, which are the recording units, and recorded on an information storage medium. Also, subtitle data for subtitles added to video data contained in the clip are recorded in a separate area. Further, font data needed to convert the subtitle data into graphic data is recorded in a separate area.

The video data is divided into reproducing units that are continuously reproducible, and usually, this reproducing unit includes a plurality of clips. As an embodiment, the size of subtitle data, which are overlappable with a video image included in one reproducing unit and is output, is limited to be less than a size when the data for a plurality of languages is all added to the subtitle data. Alternatively, subtitle data, which should be overlapped with a video image included in one reproducing unit, is divided into language sets with which a language change is continuously performable when video data is reproduced. Subtitle data included in one reproducing unit includes a plurality of language sets and the size of subtitle data included in one language set, plus data for a plurality of languages, is limited to less than a size.

The subtitle data includes character codes using Unicode and the data form actually recorded is codable by UTF-8 or UTF-16.

Video data, subtitle data for subtitles, and font data recorded in the fixed-type storage apparatus are temporarily stored in the buffer and are recorded on an information storage medium by the writer. The CPU executes a software program controlling each device so that these functions are performed in order.

As described above, according to the above-described embodiments of the present invention, text data for multi-language subtitles are made to be a text file and then recorded in a space separate from AV streams such that more diverse subtitle are providable to users and a recording space arrangement is conveniently performable.

Font data for this are made to have a minimum size by collecting characters needed for the subtitle text and are stored separately in an information storage medium and used.

Although a few embodiments of the present invention have been shown and described, the present invention is not limited to the disclosed embodiments. Rather, it would be appreciated by those skilled in the art that changes may be made in this embodiment without departing from the principles and spirit of the invention, the scope of which is defined in the claims and their equivalents.

1-58. (canceled)

59. A reproducing apparatus comprising:
a reading section which reads text data and font data;
a rendering section which renders subtitle image data from the text data;
an outputting section which outputs the subtitle image data; and
an input receiving section which receives an input to subtitle data for a next line so as to control the output time of the subtitle data.

60. The apparatus of claim 59, wherein the text data and the font data are for a plurality of languages, the subtitle information includes synchronization information for each of the plural languages, and subtitle data two or more of the plurality of languages are output at the same time.

61. (canceled)
